(19) United States
(12) Patent Application Publication
(10) Pub. No.: US 2026/0304510 A1
(43) Pub. Date: Oct. 1, 2026

(54) TECHNIQUES FOR DISCOVERY AND CONNECTION ESTABLISHMENT FOR ASSISTING NODE

(71) Applicant: QUALCOMM Incorporated, San Diego, CA (US)

(72) Inventors: Luanxia YANG, Beijing (CN); Junyi LI, Greentown, PA (US); Xiaoxia ZHANG, San Diego, CA (US); Jing SUN, San Diego, CA (US)

(21) Appl. No.: 19/479,533

(22) PCT Filed: Jun. 21, 2023
(86) PCT No.: PCT/CN2023/101612

§ 371 Date: Oct. 28, 2025

(51) Int. Cl. H04W 76/11; H02J 50/00; H04W 8/00

(52) U.S. Cl. CPC H04W 76/11; H02J 50/001; H04W 8/005

(57) ABSTRACT

Various aspects of the present disclosure generally relate to wireless communication. In some aspects, a wireless communication device may identify a user equipment (UE) of a first category (e.g., an ambient Internet of Things UE), of a plurality of categories, using a resource scheduled by a network node based at least in part on a backscattered signal, energized using energy harvesting, from the UE. The wireless communication device may initiate a connection with the UE. Numerous other aspects are described.

### FIELD OF THE DISCLOSURE

Aspects of the present disclosure generally relate to wireless communication and to techniques and apparatuses for discovery and connection establishment for an assisting node.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a wireless communication device. The method may include identifying a user equipment (UE) of a first category, of a plurality of categories, using a resource scheduled by a network node based at least in part on a backscattered signal, energized using energy harvesting, from the UE. The method may include initiating a connection with the UE.

Some aspects described herein relate to a method of wireless communication performed by a UE. The method may include identifying a wireless communication device using a resource scheduled by a network node based at least in part on a backscattered signal, from the UE, energized using energy harvested by the UE. The method may include initiating a connection with the wireless communication device.

Some aspects described herein relate to a wireless communication device for wireless communication. The wireless communication device may include one or more memories and one or more processors coupled to the one or more memories. The one or more processors may be configured to identify a UE of a first category, of a plurality of categories, using a resource scheduled by a network node based at least in part on a backscattered signal, energized using energy harvesting, from the UE. The one or more processors may be configured to initiate a connection with the UE.

Some aspects described herein relate to a UE for wireless communication. The UE may include one or more memories and one or more processors coupled to the one or more memories. The one or more processors may be configured to identify a wireless communication device using a resource scheduled by a network node based at least in part on a backscattered signal, from the UE, energized using energy harvested by the UE. The one or more processors may be configured to initiate a connection with the wireless communication device.

Some aspects described herein relate to a non-transitory computer-readable medium that stores a set of instructions for wireless communication by a wireless communication device. The set of instructions, when executed by one or more processors of the wireless communication device, may cause the wireless communication device to identify a UE of a first category, of a plurality of categories, using a resource scheduled by a network node based at least in part on a backscattered signal, energized using energy harvesting, from the UE. The set of instructions, when executed by one or more processors of the wireless communication device, may cause the wireless communication device to initiate a connection with the UE.

Some aspects described herein relate to a non-transitory computer-readable medium that stores a set of instructions for wireless communication by a UE. The set of instructions, when executed by one or more processors of the UE, may cause the UE to identify a wireless communication device using a resource scheduled by a network node based at least in part on a backscattered signal, from the UE, energized using energy harvested by the UE. The set of instructions, when executed by one or more processors of the UE, may cause the UE to initiate a connection with the wireless communication device.

Some aspects described herein relate to an apparatus for wireless communication. The apparatus may include means for identifying a UE of a first category, of a plurality of categories, using a resource scheduled by a network node based at least in part on a backscattered signal, energized using energy harvesting, from the UE. The apparatus may include means for initiating a connection with the UE.

Some aspects described herein relate to an apparatus for wireless communication. The apparatus may include means for identifying a wireless communication device using a resource scheduled by a network node based at least in part on a backscattered signal, from the apparatus, energized using energy harvested by the apparatus. The apparatus may include means for initiating a connection with the wireless communication device.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example associated with a backscatter-based passive radio frequency identification device, in accordance with the present disclosure.

FIG. 5 is a diagram illustrating an example associated with ambient Internet of Things devices, in accordance with the present disclosure.

FIG. 6 is a diagram illustrating examples of topologies for communication between a UE and a network node, in accordance with the present disclosure.

FIG. 7 is a diagram illustrating an example of discovery and connection establishment, in accordance with the present disclosure.

FIG. 8 is a diagram illustrating an example of discovery and connection establishment, in accordance with the present disclosure.

FIG. 9 is a diagram illustrating an example process performed, for example, by a wireless communication device, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Different categories of user equipment (UEs) may have different capabilities for transmission and reception. One category of UE may include ambient Internet of Things (IOT) devices, which may communicate via backscattered signaling and/or using energy harvested from an environment of the ambient IoT UE. Thus, ambient IoT devices may generally be associated with lower transmit power and coverage range than other categories of UEs, such as baseline New Radio (NR) UEs, enhanced mobile broadband (eMBB) UEs, or premium UEs. In some aspects, an ambient IoT device may be referred to as a UE of a first category.

An ambient IoT device may communicate with a network node, such as a base station or a component of a disaggregated base station. In some deployments, a wireless communication device may provide assistance for communications between the ambient IoT device and the network node. Various topologies for this assistance can be implemented. For example, a wireless communication device (e.g., a relay, an integrated access and backhaul node, a UE, a repeater, or another device capable of communicating with the ambient IoT device) may function as an intermediate node between the ambient IoT device and the network node. As another example, a wireless communication device may function as an assisting node, in which case the assisting node handles communication with the ambient IoT device in one link direction and the network node handles communication with the ambient IoT device in another direction. As yet another example, a wireless communication device may provide energy which the ambient IoT device may harvest to power communications with the wireless communication device and/or the network node, or for other operations.

An ambient IoT device may typically communicate using energy harvested from an environment of the ambient IoT device. If a wireless communication device is unaware of the presence of an ambient IoT device, it may be difficult for the wireless communication device to provide assistance for communications of the ambient IoT device. This may be exacerbated by periods of low or no power for an ambient IoT device due to an energy harvesting configuration of the ambient IoT device, in which the ambient IoT device does not perform backscattered transmission. Thus, delay or failure may occur for discovery (e.g., identification) and connection establishment for a wireless communication device providing assistance for an ambient IoT device. Furthermore, in some deployments, a wireless communication device may be capable of providing energy for communications of an ambient IoT device, whereas in other deployments, energy may be provided by a network node.

Various aspects relate generally to ambient IoT devices. Some aspects more specifically relate to discovery (e.g., identification) of ambient IoT devices. In some examples, a wireless communication device may identify a UE of a first category, such as an ambient IoT device. The wireless communication device may identify the UE using a resource scheduled by a network node, such as a resource for transmission of a discovery signal by the wireless communication device or by the UE. The wireless communication device may identify the UE based at least in part on a backscattered signal energized using energy harvesting by the UE. The energy harvested as part of the energy harvesting may be provided by the wireless communication device or by a network node. The wireless communication device may establish a connection with the UE.

Particular aspects of the subject matter described in this disclosure can be implemented to realize one or more of the following potential advantages. In some examples, by identifying the UE using the resource scheduled by the network node, the described techniques can be used to improve coexistence of ambient IoT devices and efficiency of discovery. By identifying the UE based at least in part on a backscattered signal, discovery of UEs of the first category is enabled in situations where such a UE may not have other power sources for discovery. By providing energy for the backscattered signal from the network node, energy usage at the wireless communication device is reduced and lower-capability wireless communication devices can provide assistance for the ambient IoT device. By providing energy from the wireless communication device, discovery is enabled while outside the coverage of a network node, and flexibility of discovery and connection establishment are improved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

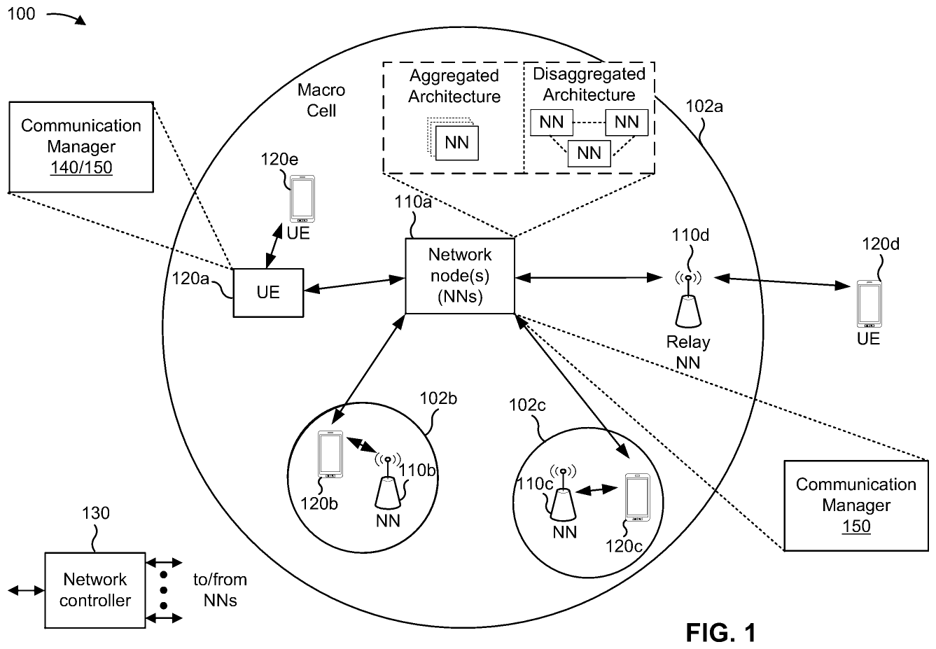

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity.

Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz- 52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a wireless communication device, such as the UE 120 or the network node 110, may include a communication manager 150. As described in more detail elsewhere herein, the communication manager 150 may identify a UE of a first category, of a plurality of categories, using a resource scheduled by a network node based at least in part on a backscattered signal, energized using energy harvesting, from the UE; and initiate a connection with the UE. Additionally, or alternatively, the communication manager 150 may perform one or more other operations described herein.

In some aspects, the UE 120 may include a communication manager 140. As described in more detail elsewhere herein, the communication manager 140 may identify a wireless communication device using a resource scheduled by a network node based at least in part on a backscattered signal, from the UE, energized using energy harvested by the UE; and initiate a connection with the wireless communication device. Additionally, or alternatively, the communication manager 140 may perform one or more other operations described herein.

As indicated above, FIG. 1 is provided as an example. Other examples may differ from what is described with regard to FIG. 1.

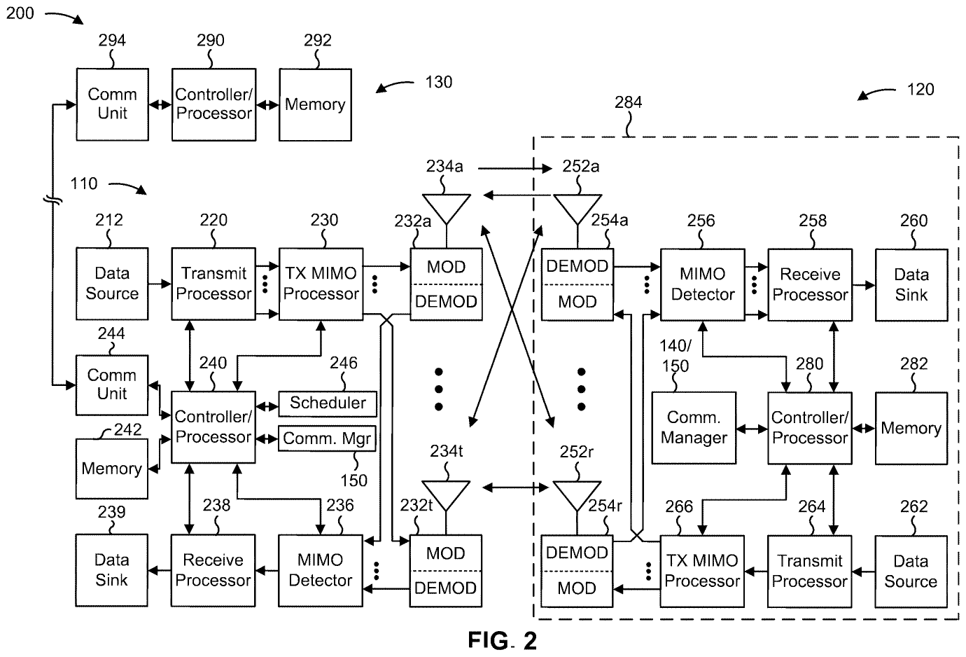

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

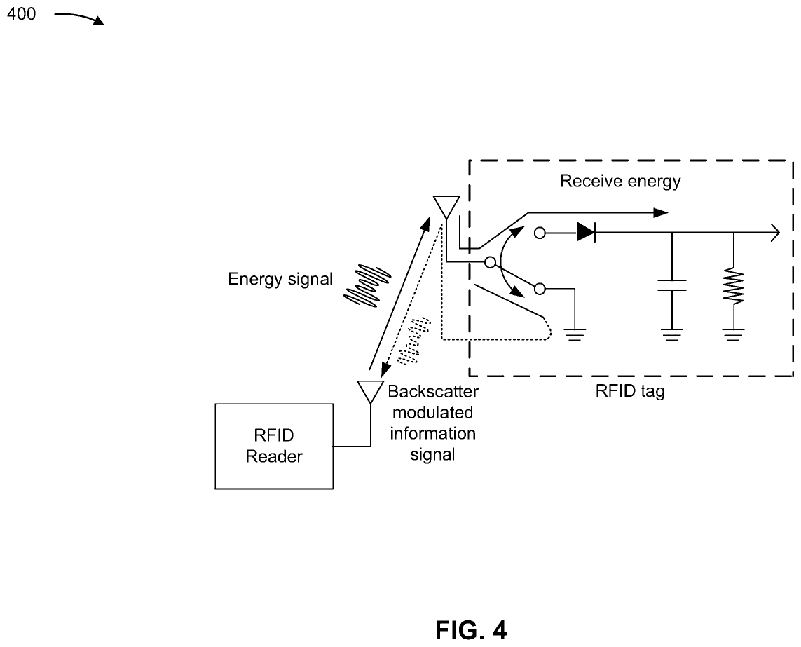

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-12).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-12).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

The controller/processor 240 of the network node 110, the controller/processor 280 of the UE 120, or any other component(s) of FIG. 2 may perform one or more techniques associated with ambient IoT, as described in more detail elsewhere herein.

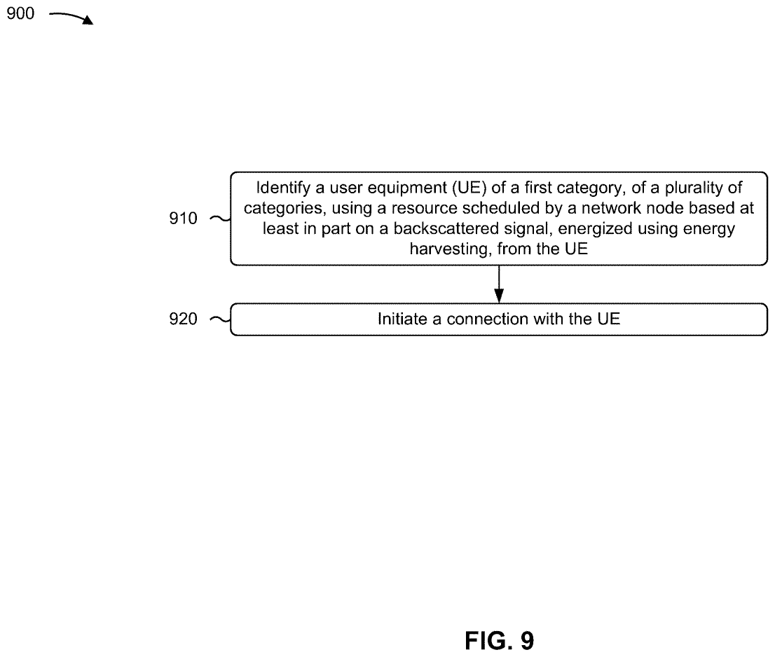

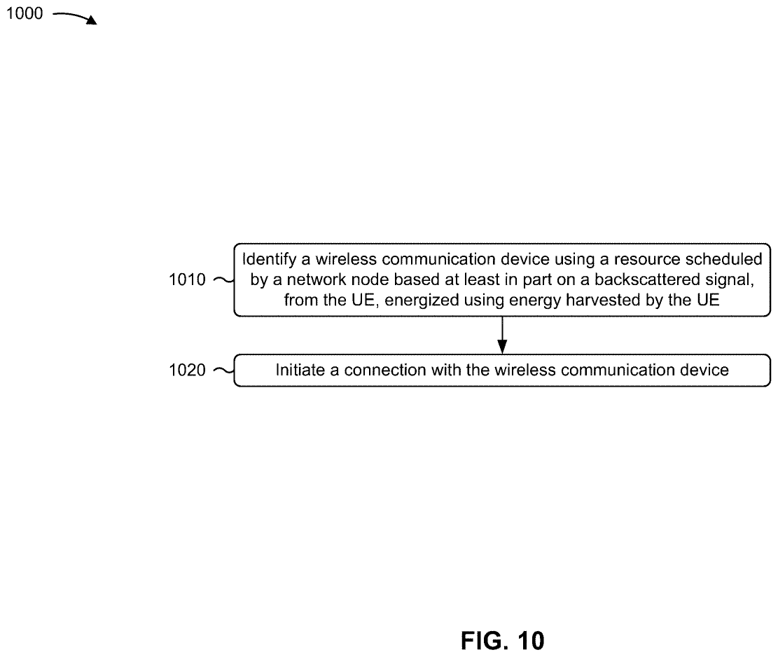

For example, the controller/processor 240 of the network node 110, the controller/processor 280 of the UE 120, or any other component(s) (or combinations of components) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication.

For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a wireless communication device (e.g., UE 120 or network node 110) includes means for identifying a UE of a first category, of a plurality of categories, using a resource scheduled by a network node based at least in part on a backscattered signal, energized using energy harvesting, from the UE; and/or means for initiating a connection with the UE. In some aspects, the means for the wireless communication device to perform operations described herein may include, for example, one or more of communication manager 150, transmit processor 220, TX MIMO processor 230, modem 232, antenna 234, MIMO detector 236, receive processor 238, controller/processor 240, memory 242, scheduler 246, antenna 252, modem 254, MIMO detector 256, receive processor 258, transmit processor 264, TX MIMO processor 266, controller/processor 280, or memory 282.

In some aspects, the UE 120 includes means for identifying a wireless communication device using a resource scheduled by a network node based at least in part on a backscattered signal, from the UE, energized using energy harvested by the UE; and/or means for initiating a connection with the wireless communication device. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

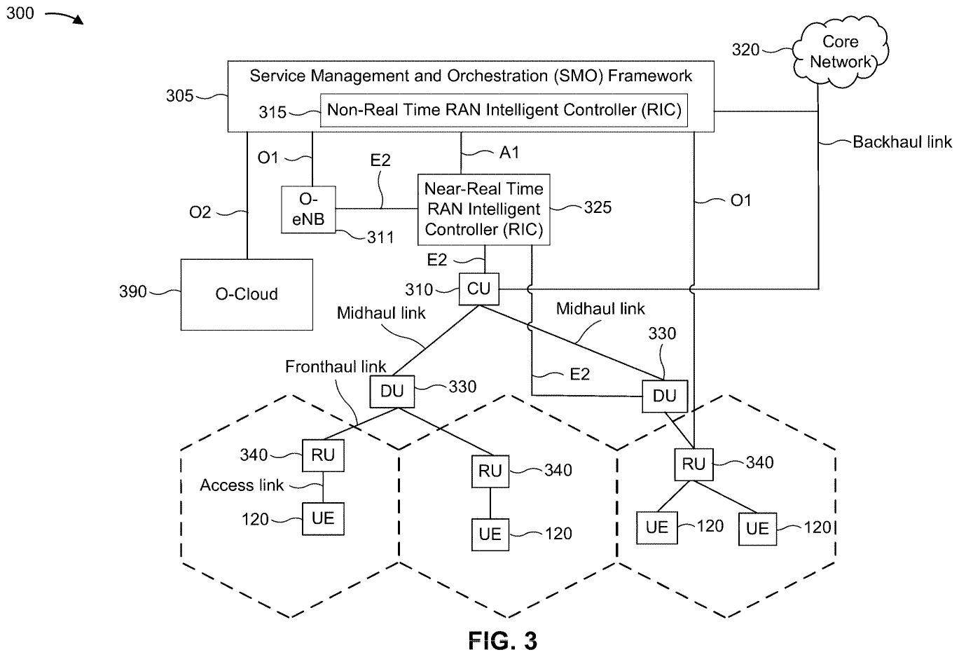

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective Ol interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 associated with a backscatter-based passive radio frequency identification (RFID) device, in accordance with the present disclosure.

RFID has applications in inventory and asset management (both inside and outside the warehouse), IoT, sustainable sensor networks in factories and/or agriculture, smart homes, or the like. RFID devices include small transponders (also referred to as tags) that emit information-bearing signals upon receiving a signal. RFID devices may be operated without battery with low operating expense, low maintenance cost, and a long life-cycle.

A passive RFID device may harvest energy over the air. For example, a passive RFID device may harvest energy from an energy signal received (in some examples) from an RFID reader. The harvested energy may power the transmission and/or reception circuitry, where the transmitted signal is typically backscatter modulated. A passive RFID device may be an example of a UE of a first category, such as an ambient IoT device.

A semi-passive RFID device may have a battery or capacitor to store energy but may be unable to generate a signal autonomously (e.g., a semi-passive RFID device may use backscattering technology to communicate). An active RFID device may be equipped with a battery and may generate a signal autonomously. Semi-passive or active RFID devices may have higher associated costs than passive RFID devices.

As indicated above, FIG. 4 is provided as an example. Other examples may differ from what is described with regard to FIG. 4.

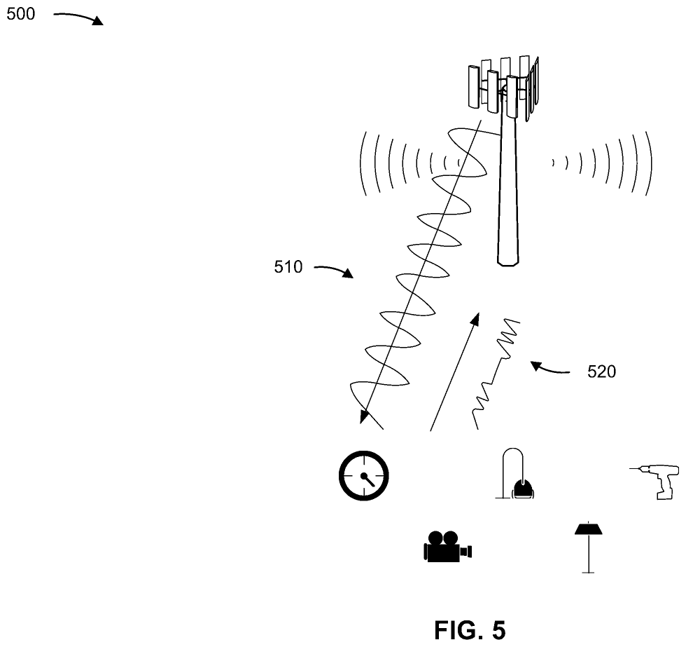

FIG. 5 is a diagram illustrating an example 500 associated with ambient IoT devices, in accordance with the present disclosure.

As 5G continues to expand into industrial verticals other than enhanced mobile broadband (eMBB) (e.g., altra-reliable low latency communications (URLLC), machine type communication (MTC), or the like), telecommunications technology may be expanded to support ambient IoT for use cases including MTC, narrowband IoT (NB-IoT), reduced capability for MTC, or the like. However, some technologies may be unable to efficiently support UEs of a first category such as ambient IoT devices (e.g., a pervasive RFID-type sensor) in many future use cases, such as asset management, logistics, warehousing, manufacturing, or the like.

As shown, telecommunication standards may enable management of ambient IoT devices. For example, as shown by reference number 510, a wireless communication device such as a network node (e.g., network node 110) may read and/or write information stored on UEs of a first category (e.g., ambient IoT devices) and/or provide energy to the ambient IoT devices As shown by reference number 520, the network entity may receive information-bearing signals reflected by the ambient IoT devices, read the reflected information-bearing signals to decode the information transmitted by the ambient IoT devices, or the like.

As indicated above, FIG. 5 is provided as an example. Other examples may differ from what is described with regard to FIG. 5.

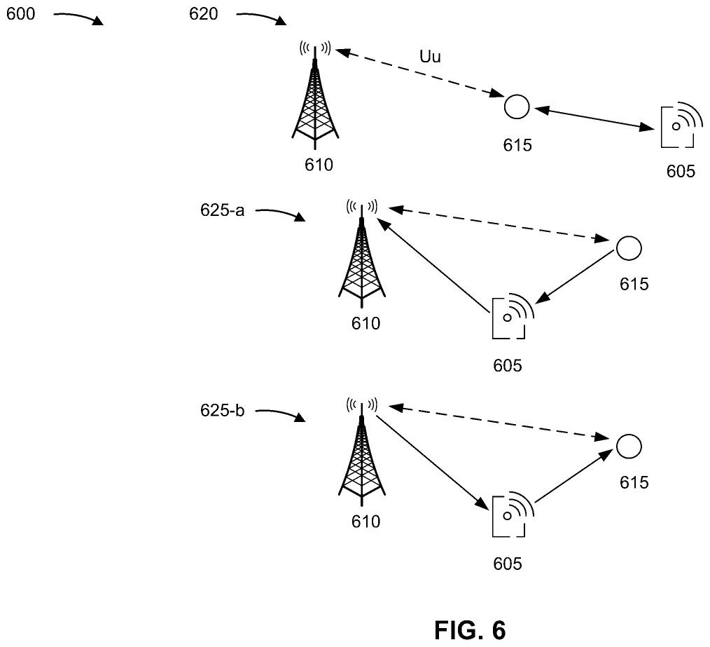

FIG. 6 is a diagram illustrating examples 600 of topologies for communication between a ambient IoT device and a network node 610, in accordance with the present disclosure. The ambient IoT device may include, for example, UE 120. The ambient IoT device may be a UE of a first category (e.g., an ambient IoT device). The network node 610 may include, for example, a network node 110 or a reader as described with regard to FIGS. 4 and 5. Some of the topologies of FIG. 6 include a wireless communication device 615 (e.g., network node 110, UE 120, a reader, a UE of a different category than the ambient IoT device), as described in more detail below. In the examples of FIG. 6, the ambient IoT device may receive energy via a carrier wave, such as from the network node 610, the wireless communication device 615, or another device. The communication links illustrated in FIG. 6 may be bidirectional or unidirectional.

In some examples (not illustrated), the network node 610 may communicate directly with the ambient IoT device without the involvement of a wireless communication device 615. This may include transmission and reception by different network nodes 610 for a single ambient IoT device. Some other topologies are also considered, such as a topology in which the ambient IoT device facilitates communication between another UE and the network node, or a topology in which no network node 610 is involved (e.g., out of coverage).

Example 620 is an example of a topology in which the wireless communication device 615 is implemented as an intermediate node. An intermediate node may include a node that relays communications between the network node 610 and the ambient IoT device without the ambient IoT device communicating directly with the network node 610. In example 620, the wireless communication device 615 may include, for example, a relay node, an IAB node, a UE, a repeater, or another device. The wireless communication device 615 may be capable of communication with the ambient IoT device. For example, the wireless communication device 615 may be capable of receiving a backscattered communication from the ambient IoT device.

Additionally, or alternatively, the wireless communication device 615 may be capable of providing energy (e.g., a continuous wave) to energize the ambient IoT device. As shown, the wireless communication device 615 may have a radio access link (e.g., a Uu interface) with the network node 610. The wireless communication device 615 and the ambient IoT device may communicate via backscattered communications from the ambient IoT device to the wireless communication device 615, or via transmission from the wireless communication device 615 to the ambient IoT device.

Example 625 (625-a and 625-b) is an example in which the wireless communication device 615 is implemented as an assisting node. An assisting node may include a node that communicates with the network node 610 and the ambient IoT device. An assisting node may differ from an intermediate node in that the ambient IoT device may also communicate directly with the network node 610. For example, as in example 625-a, the wireless communication device 615 may transmit data or signaling to the ambient IoT device, such as signaling received from the network node 610 or configured or scheduled by the network node 610 on a radio access link (e.g., a Uu interface). In example 625-a, the ambient IoT device may transmit a communication to the network node 610 via backscattered transmission. As another example, as in example 625-b, the wireless communication device 615 may receive data or signaling from the ambient IoT device, such as via backscattered transmission. The wireless communication device 615 may provide information, such as data or control signaling or information regarding the ambient IoT device, to the network node 610 on a radio access link (e.g., a Uu interface). In example 625-b, the ambient IoT device may receive downlink communications directly from the network node.

Techniques described herein provide identification (e.g., discovery) and connection establishment between the ambient IoT device and the wireless communication device 615. Techniques described herein may include discovery signal transmission and detection, as well as connection establishment. In some aspects, the wireless communication device 615 may transmit a discovery signal using a resource scheduled or configured by the network node 610, and the ambient IoT device may receive (e.g., detect) the discovery signal. This may conserve transmission resources of the ambient IoT device. In some aspects, the network node 610 may transmit a carrier wave and a command to trigger the ambient IoT device to transmit the discovery signal using backscattering transmission, and the wireless communication device 615 may receive the discovery signal. This may conserve transmission resources of the wireless communication device 615. In some aspects, the wireless communication device 615 or the network node 610 may transmit a carrier wave and a command to trigger the ambient IoT device to initiate a connection. The ambient IoT device may harvest energy from the carrier wave and may transmit a connection request using the energy. This may improve flexibility of connection establishment at the ambient IoT device. In some aspects, the wireless communication device 615 may transmit a connection request directly to the ambient IoT device. After the connection request, the wireless communication device 615 or the network node 610 may transmit a carrier wave to allow the ambient IoT device to transmit a response to the connection request via backscattering transmission.

As indicated above, FIG. 6 is provided as an example. Other examples may differ from what is described with regard to FIG. 6.

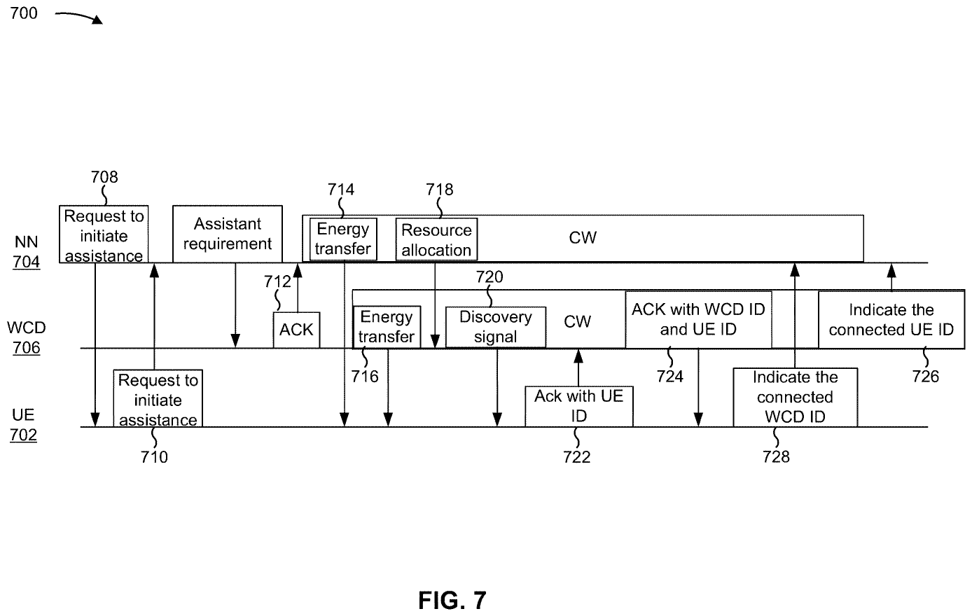

FIG. 7 is a diagram illustrating an example 700 of discovery and connection establishment, in accordance with the present disclosure. Example 700 includes a ambient IoT device 702 (e.g., UE 120, the ambient IoT device of FIG. 6, a UE of a first category), a network node 704 (e.g., network node 110, network node 610), and a wireless communication device 706 (e.g., wireless communication device 615, UE 120, network node 110). In example 700, a discovery signal is transmitted by the wireless communication device 706.

As shown by reference number 708, in some aspects, the network node 704 may transmit a request to initiate an assistance operation for the ambient IoT device 702. Additionally, or alternatively, as shown by reference number 710, the ambient IoT device 702 may transmit a request to initiate an assistance operation for the ambient IoT device 702. The wireless communication device 706 may identify the ambient IoT device 702 based at least in part on the request (e.g., in response to the request, according to parameters indicated by the request). As shown by reference number 712, the network node 704 may provide an indication for the wireless communication device 706 to provide assistance for the ambient IoT device 702 (shown as “assistance requirement”). As further shown, in some aspects, the wireless communication device 706 may transmit an acknowledgment of the indication, shown by reference number 712.

In some aspects, the network node 704 may transmit the request based at least in part on performance of a link between the network node 704 and the ambient IoT device 702. For example, if the performance is lower than a threshold, the network node 704 may transmit the request. In some aspects, the ambient IoT device 702 may transmit the request based at least in part on performance of a link. For example, the ambient IoT device 702 may transmit the request based at least in part on performance of an energy link between the ambient IoT device 702 and a device providing energy for the ambient IoT device 702, or based at least in part on performance of a downlink between the ambient IoT device 702 and the network node 704. The requests shown by reference numbers 708 or 710 may be transmitted via unicast signaling, groupcast signaling, broadcast signaling, or another form of signaling.

In some aspects, the request (e.g., the request shown by reference number 708 or the request shown by reference number 710) may include information identifying one or more target UEs (e.g., one or more UEs to receive assistance from the wireless communication device 706), such as one or more target UE identifiers, an identifier of a group of target UEs, or an indication of all possible target UEs. In some aspects, the request may include information indicating a link associated with an assistance operation (e.g., a link between the ambient IoT device 702 and the network node 704). In some aspects, the request may indicate a duration of an assistance operation (e.g., transmission or reception by the wireless communication device 706 as an intermediate node or an assisting node) associated with the connection (e.g., an available assistant duration). In some aspects, the request may indicate a link (e.g., an energy link between the ambient IoT device 702 and an energizing device, or a communication link between the ambient IoT device 702 and the network node 704) for which the assistance operation is requested. For the communication link, the request may further indicate whether the assistance operation is requested for only the downlink, only the uplink, or both the downlink and the uplink. In some aspects, the request may indicate whether the wireless communication device 706 is to provide energy for the ambient IoT device 702.

As shown by reference number 714, in some aspects, the network node 704 may provide energy for backscattered transmission by the ambient IoT device 702 (shown as “energy transfer”). For example, the network node 704 may transmit a carrier wave (“CW”) in a direction associated with the ambient IoT device 702. The rectangle may illustrate a time period in which the network node 704 may provide energy for the ambient IoT device 702. For example, communications during the time period may be powered by the carrier wave transmitted by the network node 704. As shown by reference number 716, in some other aspects, the wireless communication device 706 may provide the energy for the backscattered transmission. This energy may be used to decode a discovery signal, transmit a response to a discovery signal (e.g., an acknowledgment), initiate a connection, or the like. For example, the wireless communication device 706 may energize the ambient IoT device 702 in association with the discovery signal (e.g., the wireless communication device 706 may energize the ambient IoT device 702 during a time period in which the discovery signal is transmitted). The corresponding rectangle labeled “CW” (in which the energy transfer indicated by reference number 716 is included) may illustrate a time period in which the wireless communication device 706 may provide energy for the ambient IoT device 702. In some aspects, the network node 704 may transmit information indicating whether the network node 704 or the wireless communication device 706 is to provide the energy.

As shown by reference number 718, the network node 704 may transmit, and the wireless communication device 706 may receive, a resource allocation. For example, the network node 704 may transmit information scheduling a resource for identifying (e.g., discovering) a ambient IoT device 702. In some aspects, the network node 704 may schedule a resource for the ambient IoT device 702 to transmit a response to a discovery signal. Additionally, or alternatively, the network node 704 may schedule a resource for the wireless communication device 706 to transmit a discovery signal.

As shown by reference number 720, the wireless communication device 706 may transmit, and the ambient IoT device 702 may receive, a discovery signal. For example, the wireless communication device 706 may transmit the discovery signal on a resource scheduled by the network node 704. In some aspects, identifying the ambient IoT device 702 may include transmitting the discovery signal (and/or other actions described below). In some aspects, the ambient IoT device 702 may receive (e.g., decode) the discovery signal using harvested energy, which may be provided by the network node 704 or the wireless communication device 706.

In some aspects, the discovery signal may include an identifier of the ambient IoT device 702 (e.g., a target UE identifier). For example, the discovery signal may include such an identifier if the network node 704 indicates a target UE for the assistance or a target (e.g., specified) group of UEs of the first category. In some aspects, the discovery signal may indicate a duration of an assistance operation (e.g., transmission or reception by the wireless communication device 706 as an intermediate node or an assisting node) associated with the connection (e.g., an available assistance duration). In some aspects, the discovery signal may include information indicating a link associated with the assistance operation (e.g., a link between the ambient IoT device 702 and the network node 704). For example, for the uplink, the wireless communication device 706 may further indicate (in the discovery signal) whether the wireless communication device 706 supports full duplex or not (e.g., whether the wireless communication device 706 can transmit a carrier wave and received backscattered information simultaneously). In some aspects, the discovery signal may indicate an identifier of the wireless communication device 706. In some aspects, the discovery signal may indicate a resource for a backscattered signal, such as the acknowledgment of the discovery signal described at reference number 722 below (which may be particularly suitable for when the wireless communication device 706 assists with downlink transmission).

As shown by reference number 722, in some aspects, the ambient IoT device 702 may transmit, and the wireless communication device 706 may receive, a message which may comprise an acknowledgment of the discovery signal. For example, the acknowledgment may include a device identifier of the ambient IoT device 702. In some aspects, the ambient IoT device 702 may transmit the acknowledgment (or other information indicating an identifier of the ambient IoT device 702) using a resource scheduled by the network node 704.

As shown by reference number 724, in some aspects, the wireless communication device 706 may transmit, and the ambient IoT device 702 may receive, a message which may comprise an acknowledgment. In some aspects, the acknowledgment (or another signal transmitted by the wireless communication device 706) may include an identifier of the ambient IoT device 702 and an identifier of the wireless communication device 706. In some aspects, the ambient IoT device 702 and the wireless communication device 706 may initiate a connection with one another according to the discovery signal shown by reference number 720, the acknowledgment shown by reference number 722, the acknowledgment shown by reference number 724, or a combination thereof. In some aspects, initiating the connection may include receiving the acknowledgment shown by reference number 722 and/or transmitting the acknowledgment shown by reference number 724. In some aspects, the ambient IoT device 702 or the wireless communication device 706 may transmit information indicating an identifier (e.g., an identifier of the ambient IoT device 702 or an identifier of the wireless communication device 706) without such information being included in an acknowledgment. For example, the ambient IoT device 702 or the wireless communication device 706 may transmit information indicating an identifier. Thus, the wireless communication device 706 may identify the ambient IoT device 702 using the resource scheduled by the network node 704 and a backscattered signal (e.g., the acknowledgment of the discovery signal shown by reference number 722, which may be transmitted on the resource). The backscattered signal may be energized by the ambient IoT device 702 using energy harvesting.

As shown by reference number 726, in some aspects, the wireless communication device 706 may transmit, and the network node 704 may receive, an indication of an identifier of the ambient IoT device 702. As shown by reference number 728, in some other aspects, the ambient IoT device 702 may transmit, and the network node 704 may receive, the indication of the identifier of the wireless communication device 706. In some aspects, “initiating a connection” may include transmitting (by the ambient IoT device 702 or the wireless communication device 706) an indication of an identifier of the ambient IoT device 702 and/or an identifier of the wireless communication device 706 to the network node 704.

As indicated above, FIG. 7 is provided as an example. Other examples may differ from what is described with regard to FIG. 7.

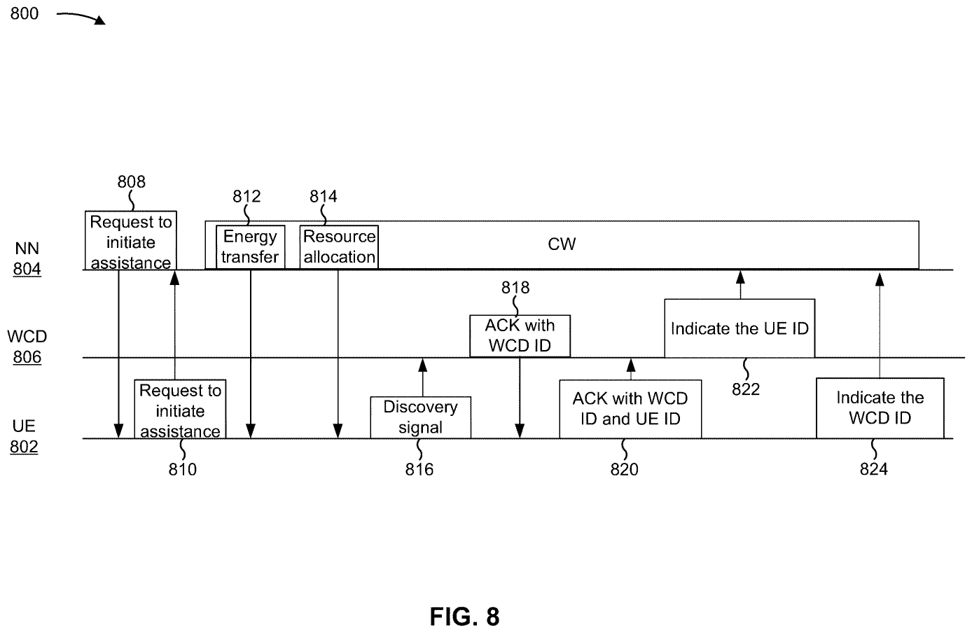

FIG. 8 is a diagram illustrating an example 800 of discovery and connection establishment, in accordance with the present disclosure. Example 800 includes a ambient IoT device 802 (e.g., UE 120, the ambient IoT device of FIG. 6, ambient IoT device 702, a UE of a first category), a network node 804 (e.g., network node 110, network node 610, network node 704, network node 804), and a wireless communication device 806 (e.g., wireless communication device 615, wireless communication device 706, wireless communication device 806, UE 120, network node 110). In example 800, the ambient IoT device 802 transmits the discovery signal.

As shown by reference number 808, in some aspects, the network node 804 may transmit a request to initiate an assistance operation for the ambient IoT device 802. Additionally, or alternatively, as shown by reference number 810, the ambient IoT device 802 may transmit a request to initiate an assistance operation for the ambient IoT device 802. The request may include any of the information described with regard to the request to initiate the assistance operation of example 700.

As shown by reference number 812, and as described with regard to FIG. 7, the network node 804 may provide energy for backscattered transmission by the ambient IoT device 802 (shown as “energy transfer”). For example, the network node 804 may transmit a carrier wave (“CW”), as illustrated by a rectangle labeled “CW”. The rectangle may illustrate a time period in which the network node 804 may provide energy for the ambient IoT device 802. For example, communications during the time period may be powered by the carrier wave transmitted by the network node 804. As another example, the ambient IoT device 702 may perform other operations (e.g., reception, processing, decoding) using energy harvested from the carrier wave.

As shown by reference number 814, the network node 804 may transmit, and the ambient IoT device 802 may receive, a resource allocation. For example, the network node 804 may transmit information scheduling a resource for identifying (e.g., discovering) a ambient IoT device 802. In some aspects, the network node 804 may schedule a resource for the ambient IoT device 802 to transmit a discovery signal.

Additionally, or alternatively, the network node 804 may schedule a resource for the wireless communication device 806 to respond to the discovery signal.

As shown by reference number 816, the ambient IoT device 802 may transmit, and the wireless communication device 806 may receive, a discovery signal. For example, the ambient IoT device 802 may transmit the discovery signal on the resource scheduled by the network node 804. In some aspects, the discovery signal may include an identifier of the ambient IoT device 802 (e.g., a target UE identifier). For example, the discovery signal may include such an identifier if the network node 804 indicates a target UE for the assistance or a target (e.g., specified) group of UEs of the first category. In some aspects, the discovery signal may indicate a duration of an assistance operation (e.g., transmission or reception by the wireless communication device 806 as an intermediate node or an assisting node) associated with the connection (e.g., an available assistant duration). For example, the discovery signal may indicate the whole duration and detailed assistant duration. In some aspects, the discovery signal may include information indicating a link associated with the assistance operation (e.g., a link between the ambient IoT device 802 and the network node 804). For example, for the uplink, the wireless communication device 806 may further indicate (in the discovery signal) whether the wireless communication device 806 supports full duplex or not (e.g., whether the wireless communication device 806 can transmit a carrier wave and received backscattered information simultaneously). In some aspects, the discovery signal may indicate an identifier of the wireless communication device 806, such as an identifier specific to the wireless communication device 806 or an identifier of a group of devices including the wireless communication device 806. In some aspects, the discovery signal may indicate a resource for a response to the discovery signal described at reference number 818 below.

As shown by reference number 818, in some aspects, the wireless communication device 806 may transmit, and the ambient IoT device 802 may receive, a message which may comprise an acknowledgment of the discovery signal. For example, the acknowledgment may include a device identifier of the wireless communication device 806.

As shown by reference number 820, in some aspects, the ambient IoT device 802 may transmit, and the wireless communication device 806 may receive, a message which may comprise an acknowledgment. In some aspects, the ambient IoT device 802 and the wireless communication device 806 may establish a connection with one another according to the discovery signal shown by reference number 816, the acknowledgment shown by reference number 818, the acknowledgment shown by reference number 820, or a combination thereof. In some aspects, the ambient IoT device 802 may transmit the acknowledgment using backscattered transmission. The acknowledgment transmitted by the ambient IoT device 802 may include an identifier of the ambient IoT device 802 and an identifier of the wireless communication device 806. In some aspects, “initiating a connection” may include transmitting (by the ambient IoT device 802 or the wireless communication device 806) an indication of an identifier of the ambient IoT device 802 and/or an identifier of the wireless communication device 806 to the network node 804.

As shown by reference number 822, in some aspects, the wireless communication device 806 may transmit, and the network node 804 may receive, an indication of an identifier of the ambient IoT device 802. As shown by reference number 824, in some other aspects, the ambient IoT device 802 may transmit, and the network node 804 may receive, the indication of the identifier of the wireless communication device 806 (e.g., a wireless communication device (WCD) identifier (ID)).

As indicated above, FIG. 8 is provided as an example. Other examples may differ from what is described with regard to FIG. 8.

FIG. 9 is a diagram illustrating an example process 900 performed, for example, by a wireless communication device, in accordance with the present disclosure. Example process 900 is an example where the wireless communication device (e.g., UE 120, network node 110, the wireless communication device of FIG. 5, wireless communication device 615, wireless communication device 706, wireless communication device 806) performs operations associated with discovery and connection establishment for an assisting node (e.g., the wireless communication device).

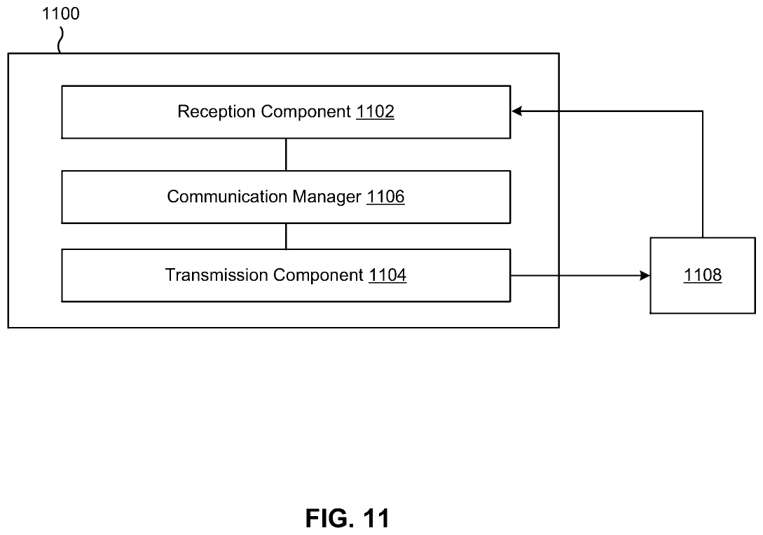

As shown in FIG. 9, in some aspects, process 900 may include identifying a UE of a first category, of a plurality of categories, using a resource scheduled by a network node based at least in part on a backscattered signal, energized using energy harvesting, from the UE (block 910). For example, the wireless communication device (e.g., using communication manager 1106, depicted in FIG. 11) may identify a UE of a first category, of a plurality of categories, using a resource scheduled by a network node based at least in part on a backscattered signal, energized using energy harvesting, from the UE, as described above. The first category may be an ambient IoT device category.

As further shown in FIG. 9, in some aspects, process 900 may include initiating a connection with the UE (block 920). For example, the wireless communication device (e.g., using communication manager 1106, depicted in FIG. 11) may initiate a connection with the UE, as described above.

Process 900 may include additional aspects, such as any single aspect or any combination of aspects described below and/or in connection with one or more other processes described elsewhere herein.

In a first aspect, the identification of the UE using the resource further comprises transmitting a discovery signal using the resource.

In a second aspect, alone or in combination with the first aspect, process 900 includes energizing the UE in association with the discovery signal.

In a third aspect, alone or in combination with one or more of the first and second aspects, process 900 includes receiving the backscattered signal, wherein the backscattered signal includes an identifier of the UE.

In a fourth aspect, alone or in combination with one or more of the first through third aspects, process 900 includes transmitting, to the UE, information indicating the identifier of the UE and an identifier of the wireless communication device.

In a fifth aspect, alone or in combination with one or more of the first through fourth aspects, the initiation of the connection further comprises transmitting information indicating the identifier of the UE to the network node.

In a sixth aspect, alone or in combination with one or more of the first through fifth aspects, the discovery signal includes at least one of a target UE identifier, a duration of an assistance operation associated with the connection, information indicating a link associated with the assistance operation, or a resource for the backscattered signal.

In a seventh aspect, alone or in combination with one or more of the first through sixth aspects, process 900 includes receiving, from the network node, a request to initiate an assistance operation, wherein the identification of the UE is based at least in part on the request.

In an eighth aspect, alone or in combination with one or more of the first through seventh aspects, the request includes at least one of a target UE identifier, a duration of the assistance operation, information indicating a link associated with the assistance operation, or information indicating whether the wireless communication device is to energize the UE.

In a ninth aspect, alone or in combination with one or more of the first through eighth aspects, the identification of the UE further comprises receiving the backscattered signal using the resource, wherein the backscattered signal includes a discovery signal.

In a tenth aspect, alone or in combination with one or more of the first through ninth aspects, the discovery signal includes at least one of an identifier of the UE, an identifier of the wireless communication device, a duration of an assistance operation associated with the connection, information indicating a link associated with the assistance operation, or a response resource on which to respond to the discovery signal.

In an eleventh aspect, alone or in combination with one or more of the first through tenth aspects, process 900 includes transmitting a response to the discovery signal to the UE, wherein the response indicates an identifier of the wireless communication device.

In a twelfth aspect, alone or in combination with one or more of the first through eleventh aspects, process 900 includes energizing the UE in association with a backscattered transmission of information indicating an identifier of the UE or an identifier of the wireless communication device.

In a thirteenth aspect, alone or in combination with one or more of the first through twelfth aspects, process 900 includes receiving a backscattered transmission of information indicating an identifier of the UE and an identifier of the wireless communication device.

In a fourteenth aspect, alone or in combination with one or more of the first through thirteenth aspects, the initiation of the connection further comprises transmitting information indicating an identifier of the UE to the network node.

In a fifteenth aspect, alone or in combination with one or more of the first through fourteenth aspects, the connection is for an assistance operation between the UE and the network node.

In a sixteenth aspect, alone or in combination with one or more of the first through fifteenth aspects, the wireless communication device is an intermediate node between the UE and the network node.

In a seventeenth aspect, alone or in combination with one or more of the first through sixteenth aspects, the wireless communication device is an assisting node for communications between the UE and the network node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a device such as a UE, in accordance with the present disclosure. Example process 1000 is an example where the device (e.g., UE 120, a UE of a first category, an ambient IoT device (sometimes referred to as a UE of a first category), ambient IoT device 702, ambient IoT device 802) performs operations associated with discovery and connection establishment for assisting node.

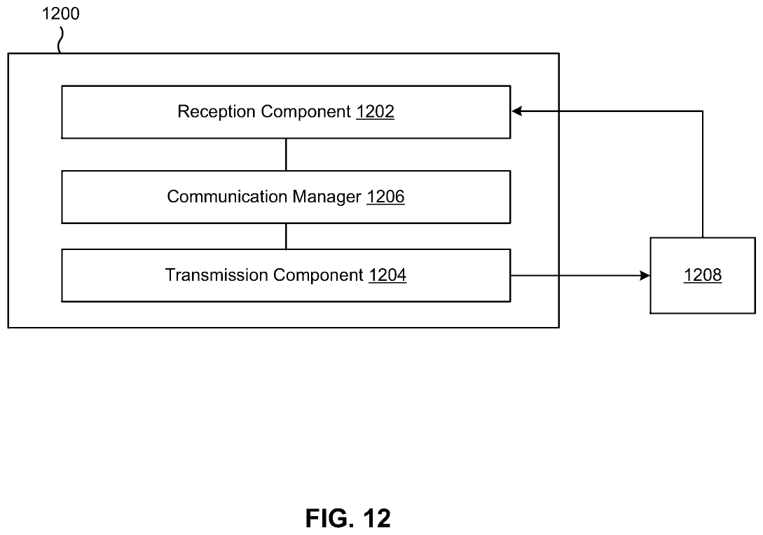

As shown in FIG. 10, in some aspects, process 1000 may include identifying a wireless communication device using a resource scheduled by a network node based at least in part on a backscattered signal, from the device, energized using energy harvested by the device (block 1010). For example, the device (e.g., using communication manager 1206, depicted in FIG. 12) may identify a wireless communication device using a resource scheduled by a network node based at least in part on a backscattered signal, from the device energized using energy harvested by the device, as described above.

As further shown in FIG. 10, in some aspects, process 1000 may include initiating a connection with the wireless communication device (block 1020). For example, the device (e.g., using communication manager 1206, depicted in FIG. 12) may initiate a connection with the wireless communication device, as described above.

Process 1000 may include additional aspects, such as any single aspect or any combination of aspects described below and/or in connection with one or more other processes described elsewhere herein.

In a first aspect, the identification of the wireless communication device using the resource further comprises receiving a discovery signal from the wireless communication device.

In a second aspect, alone or in combination with the first aspect, process 1000 includes decoding the discovery signal using energy received from the wireless communication device or the network node.

In a third aspect, alone or in combination with one or more of the first and second aspects, process 1000 includes transmitting the backscattered signal, wherein the backscattered signal includes an identifier of the device.

In a fourth aspect, alone or in combination with one or more of the first through third aspects, process 1000 includes receiving, from the wireless communication device, information indicating the identifier of the device and an identifier of the wireless communication device.

In a fifth aspect, alone or in combination with one or more of the first through fourth aspects, the initiation of the connection further comprises transmitting information indicating the identifier of the device to the network node.

In a sixth aspect, alone or in combination with one or more of the first through fifth aspects, the discovery signal includes at least one of a target device identifier, a duration of an assistance operation associated with the connection, information indicating a link associated with the assistance operation, or a resource for the backscattered signal.

In a seventh aspect, alone or in combination with one or more of the first through sixth aspects, process 1000 includes transmitting, to the network node, a request to initiate an assistance operation, wherein the identification of the wireless communication device is based at least in part on the request.

In an eighth aspect, alone or in combination with one or more of the first through seventh aspects, the request includes at least one of a target device identifier, a duration of the assistance operation, information indicating a link associated with the assistance operation, or information indicating whether the wireless communication device is to energize the device.

In a ninth aspect, alone or in combination with one or more of the first through eighth aspects, the identification of the wireless communication device further comprises transmitting the backscattered signal using the resource, wherein the backscattered signal includes a discovery signal.

In a tenth aspect, alone or in combination with one or more of the first through ninth aspects, the discovery signal includes at least one of an identifier of the device, an identifier of the wireless communication device, a duration of an assistance operation associated with the connection, information indicating a link associated with the assistance operation, or a response resource on which to respond to the discovery signal.

In an eleventh aspect, alone or in combination with one or more of the first through tenth aspects, process 1000 includes receiving a response to the discovery signal, wherein the response indicates an identifier of the wireless communication device.

In a twelfth aspect, alone or in combination with one or more of the first through eleventh aspects, process 1000 includes transmitting a backscattered transmission of information indicating an identifier of the device and an identifier of the wireless communication device.

In a thirteenth aspect, alone or in combination with one or more of the first through twelfth aspects, the backscattered transmission uses energy from the network node or the wireless communication device.

In a fourteenth aspect, alone or in combination with one or more of the first through thirteenth aspects, the initiation of the connection further comprises transmitting information indicating an identifier of the device to the network node.

In a fifteenth aspect, alone or in combination with one or more of the first through fourteenth aspects, the connection is for an assistance operation between the device and the network node.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a wireless communication device, or a wireless communication device may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the wireless communication device described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the wireless communication device described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE 120 or the network node 110 described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may identify a UE of a first category, of a plurality of categories, using a resource scheduled by a network node based at least in part on a backscattered signal, energized using energy harvesting, from the UE. The communication manager 1106 may initiate a connection with the UE.

The communication manager 1106 may energize the UE in association with the discovery signal.

The reception component 1102 may receive the backscattered signal, wherein the backscattered signal includes an identifier of the UE.

The transmission component 1104 may transmit, to the UE, information indicating the identifier of the UE and an identifier of the wireless communication device.

The reception component 1102 may receive, from the network node, a request to initiate an assistance operation, wherein the identification of the UE is based at least in part on the request.

The transmission component 1104 may transmit a response to the discovery signal to the UE, wherein the response indicates an identifier of the wireless communication device.

The communication manager 1106 may energize the UE in association with a backscattered transmission of information indicating an identifier of the UE or an identifier of the wireless communication device.

The reception component 1102 may receive a backscattered transmission of information indicating an identifier of the UE and an identifier of the wireless communication device.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a UE (e.g., an ambient IoT device), or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 2.

Additionally, or alternatively, one or more components shown in FIG. 12 may be implemented within one or more components described in connection with FIG. 2.

Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The communication manager 1206 may identify a wireless communication device using a resource scheduled by a network node based at least in part on a backscattered signal, from the UE, energized using energy harvested by the UE. The communication manager 1206 may initiate a connection with the wireless communication device.

The communication manager 1206 may decode the discovery signal using energy received from the wireless communication device or the network node.

The transmission component 1204 may transmit the backscattered signal, wherein the backscattered signal includes an identifier of the UE.

The reception component 1202 may receive, from the wireless communication device, information indicating the identifier of the UE and an identifier of the wireless communication device.

The transmission component 1204 may transmit, to the network node, a request to initiate an assistance operation, wherein the identification of the wireless communication device is based at least in part on the request.

The reception component 1202 may receive a response to the discovery signal, wherein the response indicates an identifier of the wireless communication device.

The transmission component 1204 may transmit a backscattered transmission of information indicating an identifier of the UE and an identifier of the wireless communication device.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a wireless communication device, comprising: identifying a user equipment (UE) of a first category, of a plurality of categories, using a resource scheduled by a network node based at least in part on a backscattered signal, energized using energy harvesting, from the UE; and initiating a connection with the UE.

Aspect 2: The method of Aspect 1, wherein the identification of the UE using the resource further comprises transmitting a discovery signal using the resource.

Aspect 3: The method of Aspect 2, further comprising energizing the UE in association with the discovery signal.

Aspect 4: The method of Aspect 2, further comprising receiving the backscattered signal, wherein the backscattered signal includes an identifier of the UE.

Aspect 5: The method of Aspect 4, further comprising transmitting, to the UE, information indicating the identifier of the UE and an identifier of the wireless communication device.

Aspect 6: The method of Aspect 4, wherein the initiation of the connection further comprises transmitting information indicating the identifier of the UE to the network node.

Aspect 7: The method of Aspect 2, wherein the discovery signal includes at least one of: a target UE identifier, a duration of an assistance operation associated with the connection, information indicating a link associated with the assistance operation, or a resource for the backscattered signal.

Aspect 8: The method of any of Aspects 1-7, further comprising receiving, from the network node, a request to initiate an assistance operation, wherein the identification of the UE is based at least in part on the request.

Aspect 9: The method of Aspect 8, wherein the request includes at least one of: a target UE identifier, a duration of the assistance operation, information indicating a link associated with the assistance operation, or information indicating whether the wireless communication device is to energize the UE.

Aspect 10: The method of any of Aspects 1-9, wherein the identification of the UE further comprises receiving the backscattered signal using the resource, wherein the backscattered signal includes a discovery signal.

Aspect 11: The method of Aspect 10, wherein the discovery signal includes at least one of: an identifier of the UE, an identifier of the wireless communication device, a duration of an assistance operation associated with the connection, information indicating a link associated with the assistance operation, or a response resource on which to respond to the discovery signal.

Aspect 12: The method of Aspect 10, further comprising transmitting a response to the discovery signal to the UE, wherein the response indicates an identifier of the wireless communication device.

Aspect 13: The method of Aspect 10, further comprising energizing the UE in association with a backscattered transmission of information indicating an identifier of the UE or an identifier of the wireless communication device.

Aspect 14: The method of Aspect 10, further comprising receiving a backscattered transmission of information indicating an identifier of the UE and an identifier of the wireless communication device.

Aspect 15: The method of Aspect 10, wherein the initiation of the connection further comprises transmitting information indicating an identifier of the UE to the network node.

Aspect 16: The method of any of Aspects 1-15, wherein the connection is for an assistance operation between the UE and the network node.

Aspect 17: The method of Aspect 16, wherein the wireless communication device is an intermediate node between the UE and the network node.

Aspect 18: The method of Aspect 16, wherein the wireless communication device is an assisting node for communications between the UE and the network node.

Aspect 19: A method of wireless communication performed by a user equipment (UE), comprising: identifying a wireless communication device using a resource scheduled by a network node based at least in part on a backscattered signal, from the UE, energized using energy harvested by the UE; and initiating a connection with the wireless communication device.

Aspect 20: The method of Aspect 19, wherein the identification of the wireless communication device using the resource further comprises receiving a discovery signal from the wireless communication device.

Aspect 21: The method of Aspect 20, further comprising decoding the discovery signal using energy received from the wireless communication device or the network node.

Aspect 22: The method of Aspect 20, further comprising transmitting the backscattered signal, wherein the backscattered signal includes an identifier of the UE.

Aspect 23: The method of Aspect 22, further comprising receiving, from the wireless communication device, information indicating the identifier of the UE and an identifier of the wireless communication device.

Aspect 24: The method of Aspect 22, wherein the initiation of the connection further comprises transmitting information indicating the identifier of the UE to the network node.

Aspect 25: The method of Aspect 20, wherein the discovery signal includes at least one of: a target UE identifier, a duration of an assistance operation associated with the connection, information indicating a link associated with the assistance operation, or a resource for the backscattered signal.

Aspect 26: The method of any of Aspects 19-25, further comprising transmitting, to the network node, a request to initiate an assistance operation, wherein the identification of the wireless communication device is based at least in part on the request.

Aspect 27: The method of Aspect 26, wherein the request includes at least one of: a target UE identifier, a duration of the assistance operation, information indicating a link associated with the assistance operation, or information indicating whether the wireless communication device is to energize the UE.

Aspect 28: The method of any of Aspects 19-27, wherein the identification of the wireless communication device further comprises transmitting the backscattered signal using the resource, wherein the backscattered signal includes a discovery signal.

Aspect 29: The method of Aspect 28, wherein the discovery signal includes at least one of: an identifier of the UE, an identifier of the wireless communication device, a duration of an assistance operation associated with the connection, information indicating a link associated with the assistance operation, or a response resource on which to respond to the discovery signal.

Aspect 30: The method of Aspect 28, further comprising receiving a response to the discovery signal, wherein the response indicates an identifier of the wireless communication device.

Aspect 31: The method of Aspect 28, further comprising transmitting a backscattered transmission of information indicating an identifier of the UE and an identifier of the wireless communication device.

Aspect 32: The method of Aspect 31, wherein the backscattered transmission uses energy from the network node or the wireless communication device.

Aspect 33: The method of Aspect 28, wherein the initiation of the connection further comprises transmitting information indicating an identifier of the UE to the network node.

Aspect 34: The method of any of Aspects 19-33, wherein the connection is for an assistance operation between the UE and the network node.

Aspect 35: An apparatus for wireless communication at a device, comprising a processor; memory coupled with the processor; and instructions stored in the memory and executable by the processor to cause the apparatus to perform the method of one or more of Aspects 1-34.

Aspect 36: A device for wireless communication, comprising a memory and one or more processors coupled to the memory, the one or more processors configured to perform the method of one or more of Aspects 1-34.

Aspect 37: An apparatus for wireless communication, comprising at least one means for performing the method of one or more of Aspects 1-34.

Aspect 38: A non-transitory computer-readable medium storing code for wireless communication, the code comprising instructions executable by a processor to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations (that is, individually), a group of processors collectively performing or being configured to perform all of the operations, a first processor performing or being configured to perform a first operation and a second processor performing or being configured to perform a second operation (that is, collectively), or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A wireless communication device, comprising:
one or more memories; and
one or more processors, coupled to the one or more memories, individually or collectively configured to:
identify a user equipment (UE) of a first category, of a plurality of categories, using a resource scheduled by a network node based at least in part on a backscattered signal, energized using energy harvesting, from the UE; and
initiate a connection with the UE.

2. The wireless communication device of claim 1, wherein the one or more processors, to identify the UE using the resource, are individually or collectively configured to transmit a discovery signal using the resource.

3. The wireless communication device of claim 2, wherein the one or more processors are further individually or collectively configured to energize the UE in association with the discovery signal.

4. The wireless communication device of claim 2, wherein the one or more processors are further individually or collectively configured to receive the backscattered signal, wherein the backscattered signal includes an identifier of the UE.

5. The wireless communication device of claim 4, wherein the one or more processors are further individually or collectively configured to transmit, to the UE, information indicating the identifier of the UE and an identifier of the wireless communication device.

6. The wireless communication device of claim 4, wherein the one or more processors, to initiate the connection, are individually or collectively configured to transmit information indicating the identifier of the UE to the network node.

7. The wireless communication device of claim 2, wherein the discovery signal includes at least one of:
a target UE identifier,
a duration of an assistance operation associated with the connection,
information indicating a link associated with the assistance operation, or
a resource for the backscattered signal.

8. The wireless communication device of claim 1, wherein the one or more processors are further individually or collectively configured to receive, from the network node, a request to initiate an assistance operation, wherein the identification of the UE is based at least in part on the request.

9. The wireless communication device of claim 8, wherein the request includes at least one of:
a target UE identifier,
a duration of the assistance operation,
information indicating a link associated with the assistance operation, or
information indicating whether the wireless communication device is to energize the UE.

10. The wireless communication device of claim 1, wherein the one or more processors, to identify the UE, are individually or collectively configured to receive the backscattered signal using the resource, wherein the backscattered signal includes a discovery signal.

11. The wireless communication device of claim 10, wherein the discovery signal includes at least one of:
an identifier of the UE,
an identifier of the wireless communication device,
a duration of an assistance operation associated with the connection,
information indicating a link associated with the assistance operation, or
a response resource on which to respond to the discovery signal.

12. The wireless communication device of claim 10, wherein the one or more processors are further individually or collectively configured to transmit a response to the discovery signal to the UE, wherein the response indicates an identifier of the wireless communication device.

13. The wireless communication device of claim 10, wherein the one or more processors are further individually or collectively configured to energize the UE in association with a backscattered transmission of information indicating an identifier of the UE or an identifier of the wireless communication device.

14. The wireless communication device of claim 10, wherein the one or more processors are further individually or collectively configured to receive a backscattered transmission of information indicating an identifier of the UE and an identifier of the wireless communication device.

15. The wireless communication device of claim 10, wherein the initiation of the connection further comprises transmitting information indicating an identifier of the UE to the network node.

16. The wireless communication device of claim 1, wherein the connection is for an assistance operation between the UE and the network node.

17. The wireless communication device of claim 16, wherein the wireless communication device is an intermediate node between the UE and the network node.

18. The wireless communication device of claim 16, wherein the wireless communication device is an assisting node for communications between the UE and the network node.

19. A user equipment (UE) for wireless communication, comprising:
one or more memories; and
one or more processors, coupled to the one or more memories, individually or collectively configured to:
identify a wireless communication device using a resource scheduled by a network node based at least in part on a backscattered signal, from the UE, energized using energy harvested by the UE; and
initiate a connection with the wireless communication device.

20.-28. (canceled)

29. A method of wireless communication performed by a wireless communication device, comprising:
identifying a user equipment (UE) of a first category, of a plurality of categories, using a resource scheduled by a network node based at least in part on a backscattered signal, energized using energy harvesting, from the UE; and
initiating a connection with the UE.

30. (canceled)
